(19) United States
(12) Patent Application Publication
(10) Pub. No.: US 2009/0211977 A1
(43) Pub. Date: Aug. 27, 2009

(54) THROUGH-PLATE MICROCHANNEL TRANSFER DEVICES

(75) Inventor: Richard Todd Miller, Corvallis, OR (US)

Correspondence Address: KLARQUIST SPARKMAN, LLP, 121 SW SALMON STREET, SUITE 1600, PORTLAND, OR, 97204, US

(73) Assignee: Oregon State University

(21) Appl. No.: 12/393,903

(22) Filed: Feb. 26, 2009

Related U.S. Application Data
(60) Provisional application No. 61/067,515, filed on Feb. 27, 2008.

(51) Int. Cl. B01D 63/14; B01J 19/00; F28F 3/14; B23P 17/04; B01D 61/00; C02F 1/44; B01D 61/28; B01D 63/00; B01D 11/04

(52) U.S. Cl. 210/646; 165/170; 29/525; 210/650; 422/256; 210/321.72

(57) ABSTRACT

The present disclosure concerns embodiments of a microfluidic transfer device. The device mitigates risk of cross contamination between working fluids and is amenable to high-volume, low-cost manufacturing techniques. The device may be configured for mass transfer, heat transfer, or both. For instance, certain disclosed embodiments incorporate semi-permeable membranes to transfer target substances from one fluid to another. Moreover, the device may incorporate both heat and mass transfer components.

### CROSS REFERENCE TO RELATED APPLICATION

This application claims the benefit of the earlier filing date of U.S. Provisional Application No. 61/067,515, filed on Feb. 27, 2008. The entire disclosure of provisional application No. 61/067,515 is considered to be part of the disclosure of the accompanying application and is incorporated herein by reference.

### FIELD

This disclosure concerns microfluidic heat and mass transfer devices and methods for their use and manufacture.

### BACKGROUND

The advent of microchannel technology holds significant promise for heat and mass transfer applications. For instance, there are a number of important systems that require species separation, heat addition or removal, or a combination thereof Examples include removal of contaminants from groundwater, dialysis of blood, separation of potable water from contaminated water sources, pasteurization of water, miniaturized heat exchange, solvent dehydration, and fuel cell power generation.

Removal of methyl tert-butyl ether (MTBE), a gasoline additive, from groundwater is typically accomplished using granulated activated carbon or air stripping. A recent study (Development of Supported Polymeric Liquid Membrane Technology for Aqueous MTBE Mitigation, a July 2002 report prepared by Electric Power Research Institute for California Energy Commission) concluded that a separation process using supported polymeric liquid membranes can efficiently remove MTBE from water. But, improvements in flow characteristics are needed to more efficiently utilize membrane surface area. Hemodialysis, the purification of human blood external to the body, is a process used for people with renal failure. The chemical composition of blood must be controlled to perform its essential functions of bringing nutrients and oxygen to the cells of the body, and carrying waste materials away from those cells. Blood contains particles of many different sizes and types, including cells, proteins, dissolved ions, and organic waste products. Some of these particles, including proteins such as hemoglobin, are essential for the body to function properly. Others, such as urea, a waste product from protein metabolism, must be removed from the blood. Otherwise, they accumulate and interfere with normal metabolic processes. Still other particles, including many of the simple ions dissolved in the blood, are required by the body in certain concentrations that must be tightly regulated, especially when the intake of these chemicals varies.

Potable water is created from surface waters in emergency situations using forward osmosis through hydrophilic membranes, such as those manufactured by Hydration Technologies of Albany, Ore. Using membranes such as these in microchannel devices can result in much smaller and portable systems.

Laminated microchannel heat exchangers can be used for energy efficient pasteurization of water or other fluids. One such fluid is the water used to create the dialysate solution for hemodialysis. Tap water for use as dialysate can be pasteurized using microchannel heat exchangers as an on-demand, continuous flow process.

Microchannel heat exchanger systems can be smaller and lighter than conventional heat exchanger systems. Applications range from cooling integrated circuit chips to cooling of personnel spaces in armored vehicles.

Pervaporation is a particular separation technique that utilizes both heat and mass transfer. The efficiencies gained by microchannel technology benefit both phenomena. Pervaporation is used for solvent dehydration, e.g., water removal from ethanol. It is also has utility in apple juice concentration, where aromatics otherwise lost to evaporation are captured and returned to the final product.

Fuel cell technologies utilize microchannels in the flow plates that carry hydrogen and oxygen into the cell and water vapor from the cell. The U. S Department of Energy lists system size and weight as challenges that fuel cell technology must overcome to become commercially viable.

### SUMMARY

The present disclosure concerns embodiments of a microfluidic transfer device. The device may be configured for mass transfer, heat transfer, or both. For instance, certain disclosed embodiments incorporate semi-permeable membranes into microfluidic transfer devices to transfer target substances from one fluid to another. Mass transfer rates through membranes in conventional systems often are limited by diffusion rates through the relatively thick boundary layer between the bulk fluid and the membrane surface. Increasing fluid velocity near the membrane surface, for example by stirring, is a common method of decreasing the boundary layer thickness, thus the effective diffusion length. Membrane separation in a microfluidic device overcomes this difficulty using microchannels. The reduction in channel depths reduces the mass transfer limitations caused by diffusion through the bulk fluid. However, manufacturing microfluidic devices often involves complicated and slow processes that make commercial production less feasible.

Another problem with membrane separation using microfluidic devices is the inherent volume limitations that can be processed. Previously disclosed microfluidic membrane devices overcome this difficulty by stacking multiple separators in parallel to reach desired volumetric flow rates. Such microfluidic membrane devices are disclosed in U.S. application Ser. No. 11/243,937; U. S. Publication No. 2008/0093298; and U. S. Publication No. 2008/0108122, which are incorporated herein by reference. Cross contamination is a significant risk in fluid separation processes. This application is directed to embodiments of microfluidic devices that mitigate the risk of cross contamination. For example, certain disclosed embodiments use compression sealing to reduce or substantially eliminate cross contamination of fluids. Integrated into certain disclosed embodiments is a full compression seal around each fluid containing region, thereby preventing cross contamination. Moreover, the device can be manufactured using conventional low cost, high volume techniques.

Similarly, certain disclosed embodiments are useful for heat transfer systems. Incorporating thermally conductive layers into such devices allow heat to transfer from one fluid to another. Disclosed embodiments also may incorporate both heat and mass transfer components. A person of ordinary skill in the art will recognize that a number of configurations are possible and the desired application will dictate optimal configurations. Microfluidics and heat transfer technology have been described in U.S. Pat. No. 6,793,831; U.S. Pat. No. 6,688,381; U.S. Pat. No. 6,672,502; U.S. Pat. No. 5,813,235; U.S. Publication No. 2008/0006040; and U.S. Publication No. 2004/0157096, which are incorporated herein by reference.

One embodiment of the disclosed device comprises plural lamina, at least one lamina having a front side defining front side features and a back side defining backside features. The front side features may be fluidly connected to the back side features by at least one via. The laminae are interleaved by at least one transfer layer. The features on the front side may be, for instance, an inlet header and an outlet header. The features on the backside may be one or more microchannels or a flow field. In one embodiment the inlet header may comprise an inlet port and the outlet header may comprise an outlet port.

To scale the device to the desired volumetric capacity, the device may comprise a stack of plural subunits capable of performing a unit operation, such as fluid purification or heat transfer. Each subunit has a first lamina, a second lamina, and a transfer layer positioned between the back side of the first lamina and the back side of the second lamina. The device may further comprise gaskets positioned between the subunits. Each lamina comprises a first side, a second side, and at least one, and typically plural, microchannels. The plural subunits are aligned and stacked. The stack may be positioned between a first compression plate and a second compression plate. The stack may then be compressed to affect a substantial seal of all fluid containing regions.

Gasket designs for various embodiments may have a cutout for fluid to communicate between layers and/or a cutout over the fluid inlets and outlets to prevent the gasket material from sagging into the inlet and occluding flow. The transfer layers in the various embodiments may comprise cut-outs in the areas corresponding to the inlets headers and the outlets headers of adjacent layers. Similar to the gasket this prevents the transfer layer from collapsing into the headers and occluding flow.

Individual lamina may have features on the front side and the back side, the features fluidly connected by a via or vias. For instance, the laminae may comprise an inlet and an outlet on the front side and microchannels on the back side. The inlet and outlet may be associated with fluid headers or manifolds, and may be fluidly connected to opposite ends of the plural microchannels by a first via or vias and a second via or vias positioned at opposite ends of the microchannels. The fluid inlets and outlets may define support columns for preventing adjacent laminae from sagging into the inlets and outlets and occluding flow.

Vias connecting the front side and the back side may be orthogonal to the microchannels. However, it may be desirable for the vias to intersect the laminae at a non-orthogonal angle. The non-orthogonal angle may be greater than zero and less than 90, but more typically is between about 45° and about 90°. Non-orthogonal vias can provide various benefits, such as by minimizing areas of fluid stagnation or gas entrapment.

The disclosed device may be configured various ways. For instance, in one embodiment of the disclosed device, the subunits are substantially identical with respective laminae in the stack in substantially similar orientations. For instance, the subunits may all be oriented with the front side of the first lamina facing the same compression plate. Microchannels of adjacent layers within a subunit may be parallel or orthogonal to each other. Subunits with parallel microchannels may be orthogonal to adjacent subunits to maintain a compression seal around the headers.

Adjacent subunits also may be mirror images of each other and may be oriented in the stack such that the front sides of the first laminae of adjacent subunits face each other and the front sides of the second laminae of adjacent units face each other. One advantage of this embodiment is a simplified gasket design. Another advantage of this embodiment is reduced cross contamination since layers having the same fluid are adjacent to each other.

Individual laminae may have more than one independent flow path. In this embodiment the first lamina and the second lamina are substantially identical and are herein referred to as double-sided. For instance, in addition to the lamina described above, the back sides of the first lamina and the second lamina in the subunit may further comprise an inlet header and an outlet header, and the front sides of the first lamina and the second lamina may further comprise microchannels. The microchannels on the front side may be fluidly connected to the inlet header on the back side by one or more vias and fluidly connected to the outlet header on the backside by one or more vias. Rather than gaskets positioned between the subunits, transfer layers are positioned between the subunits. The transfer layers may be mass transfer layers or heat transfer layers.

This embodiment reduces the number of lamina required per transfer unit. The single sided embodiments required two laminae for each transfer unit, whereas the double-sided embodiment requires (n+1) laminae per transfer, where n is the number of desired transfer units. Thus for a device having one hundred transfer units, the double-sided embodiment only requires 101 laminae, whereas a single sided embodiment would require 200 laminae. To mitigate cross contamination between the fluid contained in the inlet and outlet on the front side and the fluid contained in the microchannels on the front side for this embodiment, the transfer layer may be substantially sealed to adjacent lamina between the inlet headers and microchannels and between the outlet headers and the microchannels. Likewise a risk of cross contamination exists on the back side, which may be similarly mitigated.

An embodiment employing through-cut microchannels also ameliorates cross contamination risk while realizing the efficiency of a double-sided embodiment. In the through-cut embodiment, a substantial portion of the plural microchannels of each lamina extend through the entire lamina thickness, namely from the front side to the back side to form through-cut microchannels. In this way, the microchannels simultaneously operate with two separation units.

The laminae of this embodiment comprise a front side and a back side, the front side having an inlet and an outlet. The inlet fluidly connects to the back side by one or more inlet vias. The one or more inlet vias fluidly connect to the through-cut microchannels by partial thickness microchannels on the backside side, and the outlet fluidly connects to the back side by one or more outlet vias. The outlet vias fluidly connect to the through-cut microchannels by partial thickness microchannels on the back side. To add stability to the through-cut microchannels, partial thickness orthogonal support structures may be spaced along the microchannels. The through-cut laminae may be arranged in subunits having a first lamina, a second lamina, and a transfer layer. The device may have plural subunits and the microchannels of the first lamina may be substantially parallel or substantially orthogonal to the microchannels of the second lamina, and the microchannels of adjacent subunits may be orthogonal.

An embodiment of a microchannels device may comprise plural laminae, at least one of the lamina having a front side defining an inlet header and an outlet header and a backside defining at least one backside feature. The inlet header and outlet header may be fluidly connected to at least one backside feature by one or more vias. One or more of the vias may be non-orthogonal. In this embodiment one or more transfer layers, defining cutouts corresponding to the inlet headers and outlet headers, interleave the laminae.

The present disclosure is also directed to a microchannel device comprising plural laminae, at least one lamina having an inlet header and an outlet header, where transfer layers defining cutouts corresponding to the inlet header(s) and the outlet header(s) interleave the laminae. Like previous embodiments, this embodiment may be configured into subunits comprising a first lamina, a second lamina and a transfer layer. One or more subunits may be stacked between compression plates. The headers may define plural support posts and ports for fluid inlet and outlet. The laminae may define microchannels and the headers may also be shaped to provide approximately equal flow-path lengths between the inlet port and the outlet port. The headers may be, for example, approximately triangular.

This embodiment, as with previously disclosed embodiments may be configured as mirror image subunits, where the front sides of the first lamina of adjacent subunits face each other and the front sides of the second lamina of adjacent subunits face each other. Additionally, the laminae may be double sided laminae or may define through-cut microchannels as previously described. Microchannels of this embodiment may have various configurations, such as parallels, herringbone patterns, or define one or more flow fields. Adjacent laminae may have microchannels substantially parallel or substantially orthogonal to each other within a subunit or between subunits.

Another embodiment of the present disclosure is a microchannel device comprising plural laminae having front sides and back sides, where at least one laminae defines a via for fluidly connecting the front side and the back side and where the via intersects the front side and the back side at a non-orthogonal angle. The device further comprises transfer layers interleaving the laminae. The laminae may have features on the front side and the back side, for instance inlet headers, outlet headers, and microchannels, and may be arranged in one or more subunits. The subunits may be stacked between compression plates, and gaskets may be placed between subunits.

The plural microchannels of the various embodiments may be substantially parallel; however other microchannels patterns may be desirable depending on the application. A person of ordinary skill in the art will recognize that the microchannels may be a nested serpentine, fractally divergent, convergent, or of a herringbone pattern. Additionally, dividers between the microchannels may be segmented to increase the active surface area of the transfer layer. For instance, the microchannels may be formed by partial thickness wall segments arranged in a herringbone pattern, and adjacent wall segments may alternate between being flush with the front side of the lamina and flush with the back side of the lamina. Alignment tolerant designs, such as a herringbone pattern or the like, may ease manufacturing constraints.

Adjacent layers of the various embodiments may be oriented so that the microchannels direct their respective fluids to flow in the same direction (concurrent), opposite directions (countercurrent), or at some angle relative to one another, such as orthogonally (crosscurrent). Design considerations will balance the need for enhanced transfer driving force (temperature gradients or concentration gradients) with difficulties in construction and operation inherent in the configurations; such difficulties include alignment and pressure differentials between layers. A person of ordinary skill in the art will recognize that the preferred relative flow direction will depend on the application.

The disclosed embodiments may be configured to perform heat transfer, mass transfer or both. The disclosed device is compatible with any membrane suitable for particular applications. Typical membranes for mass-transfer are semi-permeable membranes. Such membranes may be polymer, copolymer, metal, ceramic, composite, and/or liquid membranes. One example of a composite membrane is polysulfone-nanocrystalline cellulose composite membrane, which may be employed for a microchannel dialysis device, where metabolic waste is transferred from blood to dialysate. Gas-liquid contactor membranes may also be employed for transferring a substance between a liquid and gas. One such application would be oxygenation of blood, whereby the membrane allows transfer of carbon dioxide and oxygen, such that oxygen transfers to blood from oxygen or oxygen-enriched air, and carbon dioxide transfers from the blood to the gas. Fluid membranes may also be employed. Fluid membranes comprise a lamina having through cut microchannels containing fluid and a first and second membrane support positioned to contain fluid in the microchannels. The transfer layer may also be configured for a fuel cell where the transfer layer comprises a polymer electrolyte membrane positioned between a cathode layer and an anode layer.

Heat transfer layers may be any material which transfers heat at a sufficient rate for the desired application. Relevant factors include the thermal conductivity of the heat transfer layer, the thickness of the heat transfer layer, and the desired rate of heat transfer. Suitable materials include, without limitation, metal, metal alloy, ceramic, polymer, or composites thereof Suitable metals include, without limitation, iron, copper, aluminum, nickel, titanium, gold, silver, or tin. Copper may be a particularly desirable material.

The laminae used on the various embodiments may be any material which can be patterned with microchannel features. Typical laminae materials include polymers, metals, metal alloys, super alloys, or intermetallics. Suitable polymers include, without limitation, polycarbonate, polyethylene terephthalate (PET), polyether imide (PEI), Poly(methyl methacrylate) (PMMA), or a halogenated polyethylene such as poly(tetrafluoroethylene) (PTFE). Suitable metals or metal alloys include, without limitation, stainless steel, copper, titanium, nickel, or aluminum.

Microchannel depth generally should be as shallow as possible while still allowing the passage of fluid through the microchannel. The shallow depth determines the diffusion or conduction length, so the shallower the microchannel, the shorter the diffusion or conduction path, thus increasing transfer efficiency. To realize the benefit from the microchannel phenomenon, microchannel dimensions are typically greater than zero and less than about 1000 μm. More typically, the microchannels are greater than zero less than about 400 μm, and even more typically greater than zero and less than about 100 μm, such as from about 10 μm to about 90 μm.

The embodiments of the present disclosure may be useful for transferring heat or mass from one fluid to another. By providing an embodiment of the present disclosure having a first lamina and a second lamina, the first and second lamina each having inlet headers and outlet headers connected to microchannels separated by a transfer layer, then providing a first fluid to the inlet header of the first lamina and a second fluid to the inlet header of the second lamina, the heat or mass will transfer from the first fluid to the second fluid or visa-versa, depending on the device configuration. For instance, by providing a device where the transfer layer is a semi-permeable membrane, such as polysulfone-nanocrystalline cellulose composite, and providing blood to one lamina and dialysate to the other lamina, substances in the blood will transfer to the dialysate.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic view of a microfluidic transfer device having a through-flow via.

FIG. 2 is a perspective view of one embodiment of a single layer of the microfluidic transfer device.

FIG. 3 is a plan view of microchannel flow field.

FIG. 4 is a partial perspective view of an assembled device showing fluid inlets and outlets.

FIG. 5 is a perspective view of two combined assembled devices with fluidic headers attached.

FIG. 6 is an assembly view of one embodiment of a microfluidic transfer device with single-sided lamina.

FIG. 7 is a plan view of on embodiment of a lamina.

FIG. 8 is a perspective view of the assembled device shown in FIG. 6.

FIG. 9 is a detail view of the internal fluid flow paths in the device of FIG. 6.

FIG. 10 is a schematic plan view of the juxtaposition of fluid headers and microchannels of adjacent layers, having cross-current flow.

FIG. 11 is a partial schematic plan view of the juxtaposition of adjacent layers having the flow field shown in FIG. 3.

FIG. 12 is a detail view of the internal fluid flow paths of one embodiment having single-sided mirrored design.

FIG. 13 is a detail perspective view of the fluid flow paths of a one embodiment having a single-sided mirrored design with parallel microchannels.

FIG. 14 is a partial assembly view of one embodiment of a microfluidic transfer device having double sided laminae.

FIG. 15 is a plan view of a double-sided lamina.

FIG. 16 is a plan view of a transfer layer.

FIG. 17 is a detail view of the flow path of a microfluidic transfer device having double sided laminae.

FIG. 18 is a detail view of the flow path of a microfluidic transfer device having double sided laminae with concurrent flow.

FIG. 19 is a plan view of a lamina having through-cut microchannels.

FIG. 20 is a detail plan view of a lamina having through-cut microchannels with lateral supports.

FIG. 21 is a detail plan view of a lamina having through-cut microchannels with a herringbone pattern.

FIG. 22 is a detail perspective view of a lamina having through-cut microchannels with a herringbone pattern.

FIG. 23 is an assembly view of a microfluidic transfer device having through-cut laminae.

FIG. 24 is a detail view of the fluid flow path of a device having through-cut laminae.

FIG. 25 is a perspective view of a device having alternating parallel and orthogonal through-cut microchannels.

FIG. 26 is a plan view of the juxtaposition of the layers of a subunit incorporating a fluid membrane.

FIG. 27 is a schematic view of a device having fluid membranes.

FIG. 28 is a schematic view of a device having fuel cells.

### DETAILED DESCRIPTION

### A. Definitions

Dialysate refers to an aqueous fluid having the proper solutes in the proper concentrations for blood dialysis.

Microchannel refers to a substantially bound space in a microfluidic device that allows the flow of fluid, the space having at least one dimension less than about 1000 μm.

Through-cut microchannel refers to a microchannel with a depth equal to the thickness of the lamina in which it is formed.

Single-sided laminae refers to laminae that have features, such as microchannel features, in which heat or mass transfer across the transfer layers occurs on one side only.

Double-sided laminae refers to laminae that have features, such as microchannel features, on both sides.

Semi-permeable membrane refers to a membrane that allows passage of some substances through it while restricting others.

Via refers to a microchannel that allows fluid to flow through a lamina to fluidly connect microchannels on the lamina front side with those on the lamina back side.

### B. Microfluidic Transfer Device Description

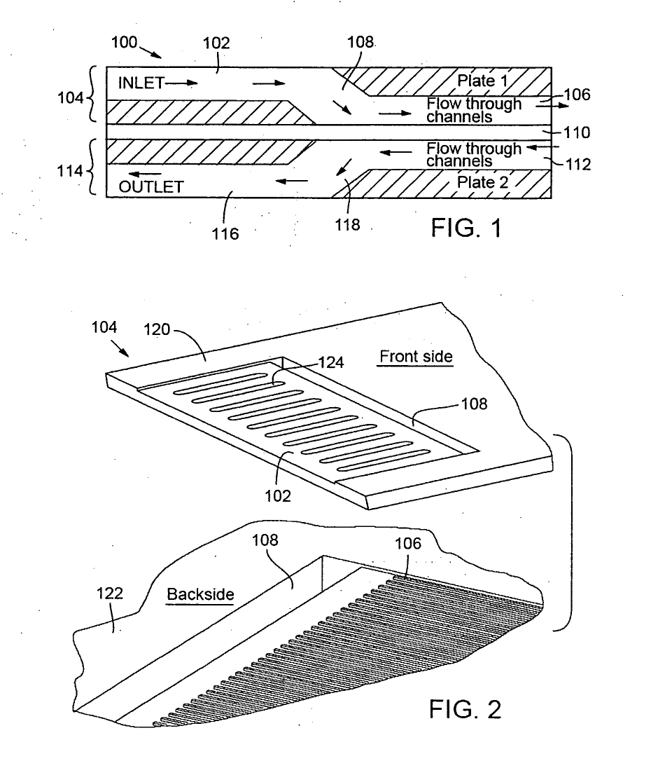

FIG. 1 is a counter current flow diagram 100 for a first fluid and a second fluid. A first fluid enters microchannel inlet 102 and flows through upper lamina 104 to microchannel 106 by way of via 108 where the fluid contacts transfer layer 110. Concurrently, a second fluid in microchannel 112 contacts transfer layer 110 before flowing through lower lamina 114 to outlet 116 by way of via 118. Transfer layer 110 may be a semipermeable membrane chosen for the specific application to allow transfer of one or more substances from the fluid in microchannel 106 to the fluid in microchannel 112, or visa-versa. Alternatively, transfer layer 110 may be a heat transfer layer for allowing heat to transfer from the fluid in microchannel 106 to the fluid in microchannel 112, or visa-versa. The width of microchannels 106 and 112 will be the widest possible considering operating parameters and construction requirements, such as to substantially prevent the transfer layer 110 from sagging into the microchannels. The actual width will vary depending on certain factors, such as the rigidity of the transfer layer 110 and the pressure differential across the transfer layer. Typical microchannel widths are between 100 μm and 500 μm, and more typically between about 200 μm and about 400 μm. Microchannel depth creates a transfer efficiency advantage. Micron scale dimensions reduce mass transfer or heat transfer limitations by reducing diffusion or conduction lengths through the bulk fluid, thereby increasing the mass or heat transfer rate per unit area of transfer layer 110, consequently increasing efficiency and reducing device size. Microchannel depth is typically greater that zero and less than 1000 μm. More typically the depth is greater that zero and less than 400 μm. Even more typically, the depth is greater that zero and less than about 100 μm.

For mass transfer devices, transfer layer 110 may be any material which allows selective transfer of a target substance(s) through the transfer layer. A person of ordinary skill in the art will recognize that the membrane selection will depend on other design criteria including, without limitation, the substance being transferred, other substances present in the fluids, the desired rate of transfer, the fluids carrying the substance, the fluid receiving the substance, operating temperature, and operating pressure. Suitable membranes may include, without limitation, polymer, copolymer, metal, ceramic, composites, polysulfone-nanocrystalline cellulose composite, gas-liquid contactor membranes, hollow fiber membranes, and fluid membranes.

For heat transfer devices, transfer layer 110 may be any material capable of conducting heat from one fluid to another at a sufficient rate for the desired application. Relevant factors include, without limitation, the thermal conductivity of the heat transfer layer 110, the thickness of the heat transfer layer, and the desired rate of heat transfer. Suitable materials include, without limitation, metal, metal alloy, ceramic, polymer, or composites thereof Suitable metals include, without limitation, iron, copper, aluminum, nickel, titanium, gold, silver, or tin. Copper may be a particularly desirable material.

Laminae 104 and 114 may be any material capable of being patterned with features useful for a particular application, such as vias and microchannels. Lamina thickness may be between about 200 μm and about 1000 μm, with typical thicknesses being between about 300 μm and about 500 μm. Suitable lamina materials include, without limitation, polymers and metals. Examples of suitable polymeric materials include polycarbonate, polyethylene terephthalate (PET), polyether imide (PEI), poly(methyl methacrylate) (PMMA), and halogenated polyethylene such as poly(tetrafluoroethylene) (PTFE). Metal laminae may be any that can have desired features formed therein, such as materials that can be photo-chemically etched or otherwise machined to have desired features, including blind features. Examples include stainless steels, copper, titanium, nickel, and aluminum.

FIG. 2 shows a perspective view of one embodiment of a lamina design. The header side 120 of lamina 104 comprises inlet 102 for receiving a fluid and directing the fluid to via 108 where the fluid flows through the plate to the microchannel side 122 of the plate. The fluid then flows through the microchannels 106, where the fluid contacts the transfer layer, not shown. The inlet 102 has support structures 124 for preventing collapse of adjacent lamina into the inlet 102.

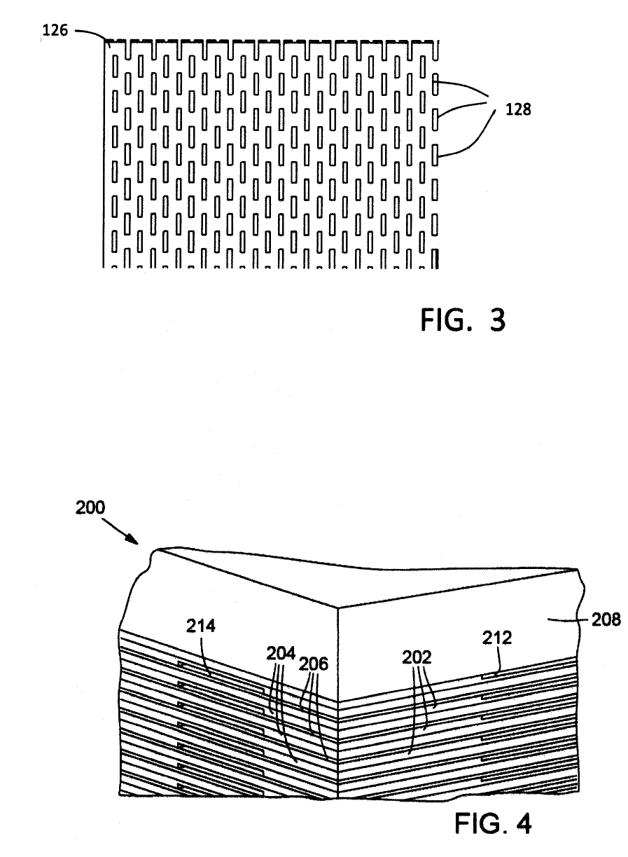

FIG. 2 discloses microchannels 106 as plural parallel microchannels, however the present disclosure is not limited to this configuration. For instance, FIG. 3 shows a flow field 126 defining plural wall segments 128. The embodiment of FIG. 3, by employing wall segments 126 rather than contiguous microchannel dividers, exposes more transfer layer surface (not shown), improving overall device efficiency. A person of ordinary skill in the art will recognized that it is desirable to maximize the area of the transfer layer exposed to the fluid.

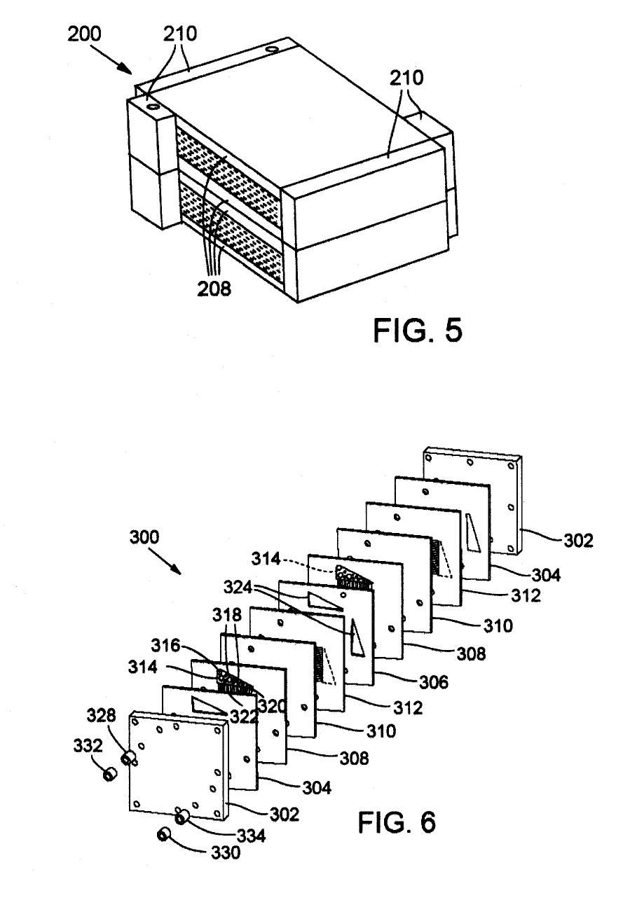

Referring to FIGS. 4 and 5, assembled mass transfer device 200 is comprised of laminae 202, laminae 204, and transfer layers 206. Compression plates 208 are provided to apply pressure to the layered plates 202 and 204 and transfer layers 206 to afford substantially sealed fluid microchannels. Compression plates 208 apply pressure using, for example, fasteners connecting the compression plates or by placing device 200 in a clamping mechanism. A person of ordinary skill in the art will recognize that various additional methods of applying force to the compression plates exist in the art. Fluidic headers 210 are operably connected to mass-transfer device 200, and are fluidly connected to microchannel inlets 212 and microchannel outlets 214, for delivering fluids to the internal microchannels 106 and 112 (FIG. 1). FIG. 5 shows two microfluidic transfer devices arranged in parallel, however a person of ordinary skill in the art will recognize that any number of devices may be configured in parallel, series, or both.

The compression plates 208 may be made from any material with sufficient rigidity to evenly compress the laminae 202 and 204 and transfer layers 206. Suitable materials include, without limitation, polymer, metals, ceramic, or composites. An exemplary material may be, for instance, acrylic. However, a person of ordinary skill in the art will recognize that the compression plate material and its thickness may depend on various factors, for instance, the number of layers in the stack, the required shape to affect a seal, and the operating temperatures. The compression plates 208 may be flat or may have a curved face, such as a convex face, having a curvature suitable for preferably evenly distributing pressure through the device 200.

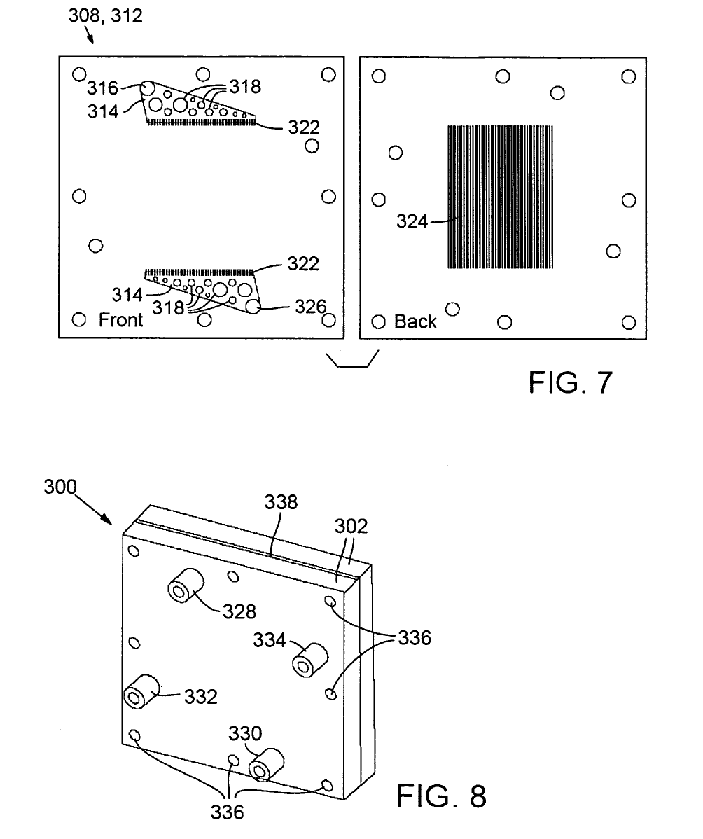

FIG. 6 shows an assembly view of one embodiment of a microfluidic transfer device 300. Mass transfer device 300 comprises a sequenced stack of lamina held between compression plates 302. The sequenced stack comprises head gaskets 304, and repeating subunits separated by gaskets 306. The repeating subunits comprise, in order, a first lamina 308, a transfer layer 310, and a second lamina 312. The number of subunits will depend on the application and the volumetric throughput and transfer capacity required. Additionally, devices may be connected in parallel as shown in FIG. 5. Laminae 308 and 312 are substantially similar in design. Referring to FIG. 7, laminae 308 and 312 have fluid headers 314, fluid inlet 316, support structures 318, vias 322, microchannels 324 located on the opposite side, and fluid outlet 326. This can be seen in more detail in the discussion of FIG. 10 below. Referring again to FIG. 6, the gaskets 304 and 306 have cutouts 324 so that the gasket does not cover the fluid headers 314, preventing collapse of the gasket material into the header and impeding fluid flow. The support structures 318 transfer compression force through the stack to facilitate compression sealing throughout the stack and prevent the adjacent lamina from collapsing into the header. Operatively connected to compression plate 302 are fluid connectors 328, 330, 332, and 334.

FIG. 8 shows a perspective view of assembled microfluidic transfer device 300. The compression plates 302 have apertures 336 for receiving fasteners for coupling together and compressing the stack 338. A first fluid enters the device 300 through fluid connector 328 and exits the device through fluid connector 330. A second fluid enters the device 300 through fluid connector 332 and exits the device through fluid connector 334.

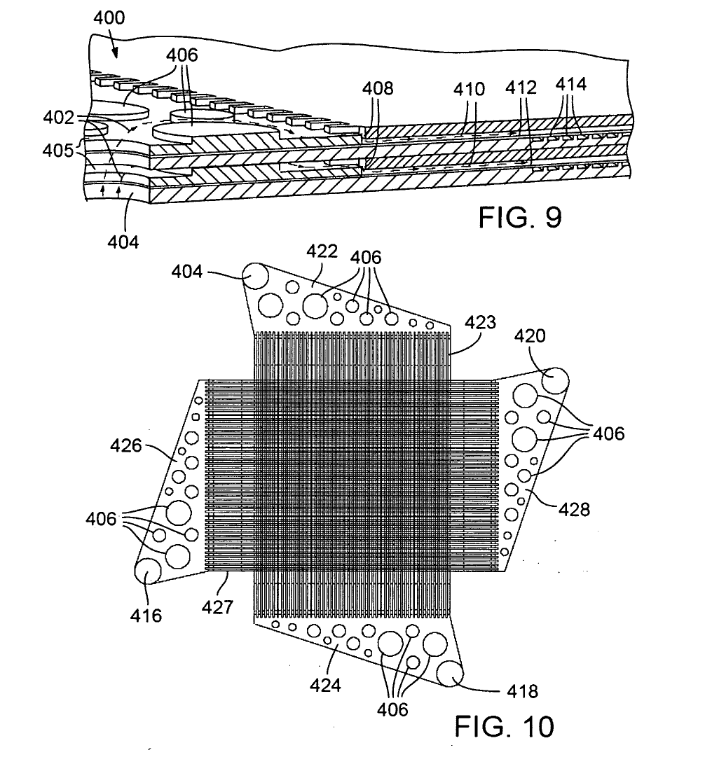

FIG. 9 provides a detailed view of the internal flow path of two subunits of stack 400. Fluid flow paths 402 show a first fluid entering through fluid inlet 404. Fluid inlet 404 is a through-hole which fluidly connects the first fluid to subunits in the stack. Fluid enters the headers 405, flows around the support structures 406 through the vias 408 to microchannels 410 where it contacts transfer layers 412. Transfer layers 412 operatively connect microchannels 410 containing the first fluid and microchannels 414 containing the second fluid to allow transfer of heat or select substances in the fluids. For instance a mass transfer layer, e.g. a membrane, may allow for membrane permeable components of the first and second fluid to transfer across the membrane from one fluid to the other.

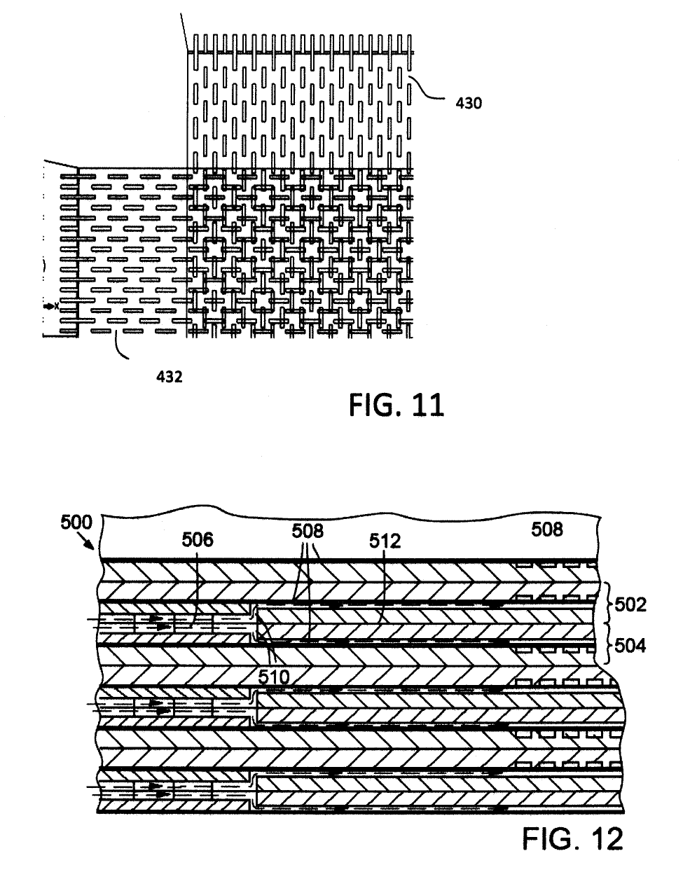

FIG. 10 is a schematic view of the fluid flow patterns of both fluids juxtaposed. Fluid inlet 404 provides the first fluid to inlet header 422, where it flows around support structures 406 to microchannels 423, and is collected at the other end of the microchannels in outlet header 424, then exits through fluid outlet 418. Likewise, the second fluid enters through fluid inlet 416 into inlet header 426, where it is directed to microchannels 427, and is collected in outlet header 428 and exits through outlet 420. FIG. 10 discloses a device having the first and the second fluid flowing orthogonal to each other; however a person of ordinary skill in the art will recognize that one may configure this device for concurrent, countercurrent, or crosscurrent flow. FIG. 11 discloses the juxtaposition of adjacent layers of another embodiment utilizing a flow fields 428 and 430 rather than plural parallel microchannels.

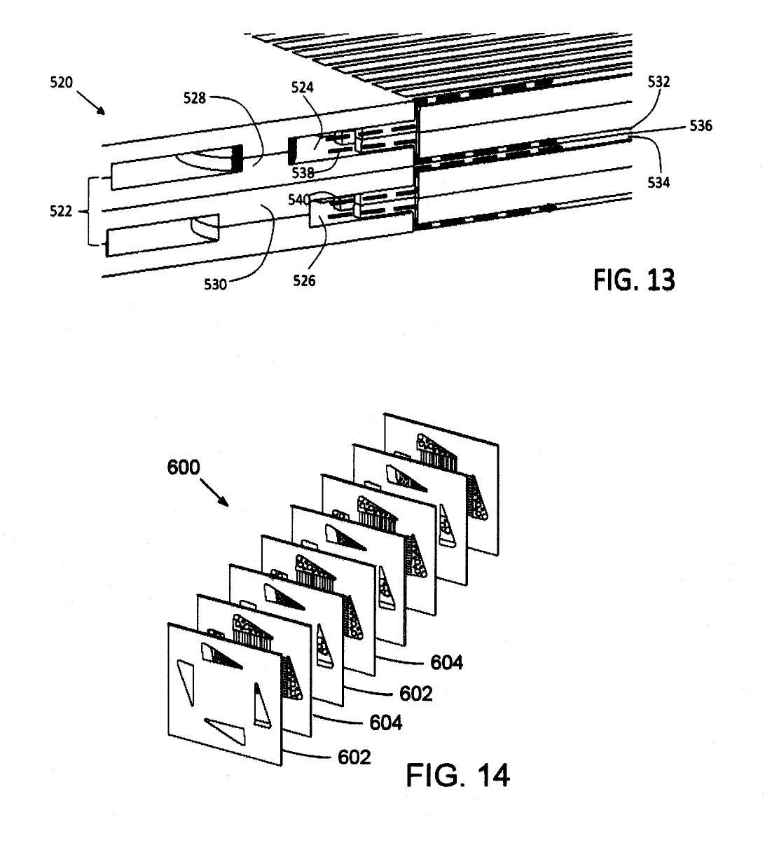

FIG. 12 discloses an embodiment of the device 500 having alternating mirror image subunits 502 and 504. This embodiment creates combined fluid header 506, which directs fluid to microchannels 508 through vias 510. The subunits 502 and 504 are separated by a gasket 512 with a cutout for header 506. This arrangement reduces the fluid cross contamination relative to embodiments having headers with dissimilar fluids facing each other. Moreover, arranging the subunits 502 and 506 in this manner allows for a single, simplified gasket design compared to the two gasket designs shown as 304 and 306 in FIG. 6. This embodiment may be configured for cross flow as shown in FIG. 12 or for concurrent or counter current flow as shown in FIG. 13.

Referring to FIG. 13, device 520 comprises subunit 522 having combined headers 524 and 526. Laminae 528 and 530 comprise parallel microchannels 532 and 534 separated by transfer layer 536. Parallel microchannels 532 and 534 allow concurrent flow paths 538 and 540. Alternatively, reversing the direction of either flow path 538 or 540 will achieve countercurrent flow.

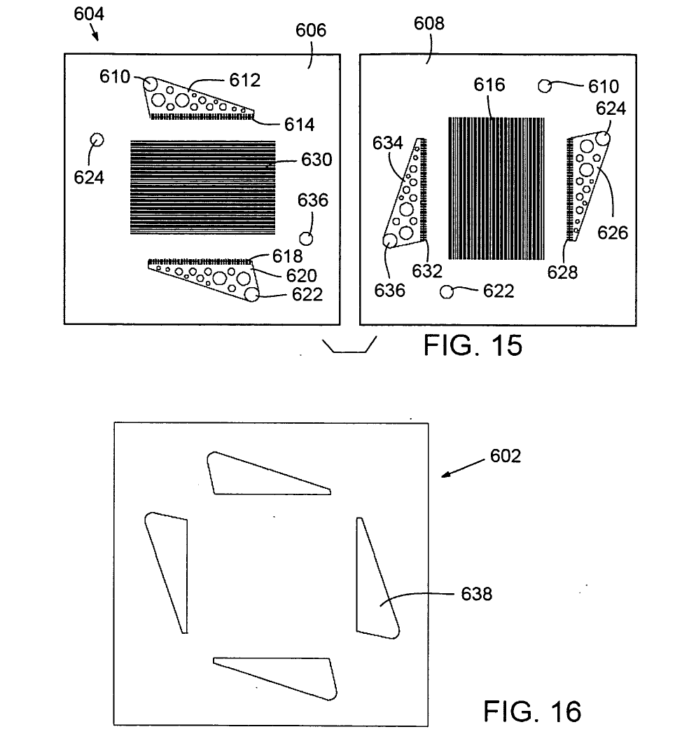

In yet another embodiment, the need for gaskets between subunits is eliminated entirely. FIG. 14 discloses a partial assembly view of a mass transfer device 600 where the laminae 604 have microchannels and headers on both sides. This configuration allows the device 600 to be assembled as alternate layers of identical transfer layers 602 and laminae 604. FIG. 15 is a plan view of the front 606 and back 608 of the lamina 604. The lamina front 606 has a first fluid inlet 610 fluidly connected to first fluid inlet header 612. First fluid inlet header 612 directs fluid through via 614 to first fluid microchannels 616 on lamina back 608. The microchannels 616 direct fluid to via 618 which fluidly connects the microchannels with first fluid outlet header 620 on lamina front 606, where the first fluid exits by first fluid outlet 622. Similarly, the lamina back 608 has second fluid inlet 624 which fluidly connects to second fluid inlet header 626. Second fluid inlet header 626 is fluidly connected to via 628 which fluidly connects the second fluid inlet header to the second fluid microchannels 630 on the lamina front 606. The second fluid microchannels 630 direct the fluid to via 632 which fluidly connects the second fluid microchannels and the second fluid outlet header 634, which is fluidly connected to the second fluid outlet 636.

FIG. 16 discloses the transfer layer 602 used in microfluidic transfer device 600 (FIG. 14). The transfer layer 602 has four cutouts 638 associated with the locations of the fluid headers 612, 620, 626, and 634 on plate 604 (FIG. 15). While the double sided lamina 604 allows a device with nearly half the number of lamina compared to previously disclosed embodiments, compression alone may not adequately seal the transfer layer between the headers and microchannels located on the same side of the lamina.

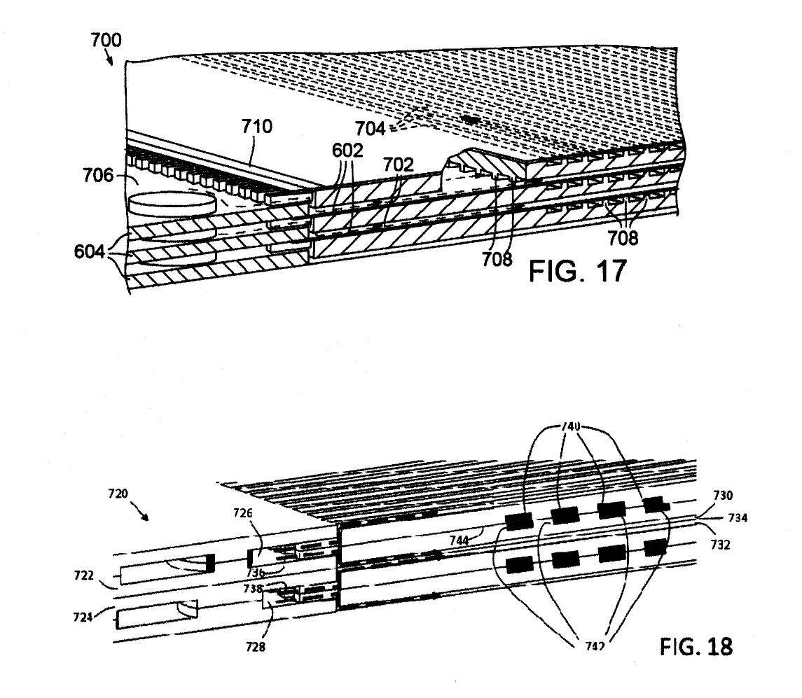

FIG. 17 shows a detailed view of a microfluidic transfer device 700 employing double sided lamina 604. The first fluid flows from the headers 706 through lamina 604 to microchannels 702. Similarly the second fluid flows from a header, not shown, on lamina 604 to microchannels 704 located on the same side of the plate as header 706. Because the transfer layer 602 is compressed against adjacent layers by microchannel dividers 708 rather than a solid surface, fluid could leak under the transfer layer allowing fluid from header 706 to enter microchannel 704. Transfer layer bond 710 prevents this. Adhesives or laser welding could create the transfer layer bond 710, however a person of skill in the art will recognize that one may employ other methods to create the bond. Such methods include but are not limited to RF welding, ultrasonic welding, and thermal welding.

While FIG. 17 discloses a double-sided device with crosscurrent flow, it is also possible to configure a double-sided device with concurrent or countercurrent flow. For example, FIG. 18 illustrates device 720 having double-sided laminae 722 and 724 arranged to provide combined headers 726 and 728. Microchannels 730 and 732 are parallel and are separated by transfer layer 734, allowing concurrent flow paths 736 and 738. Likewise microchannels 740 and 742 are parallel to each other and are separated by transfer layer 744, allowing concurrent flow paths not shown. A person of ordinary skill in the art will recognize that this embodiment also allows countercurrent flow.

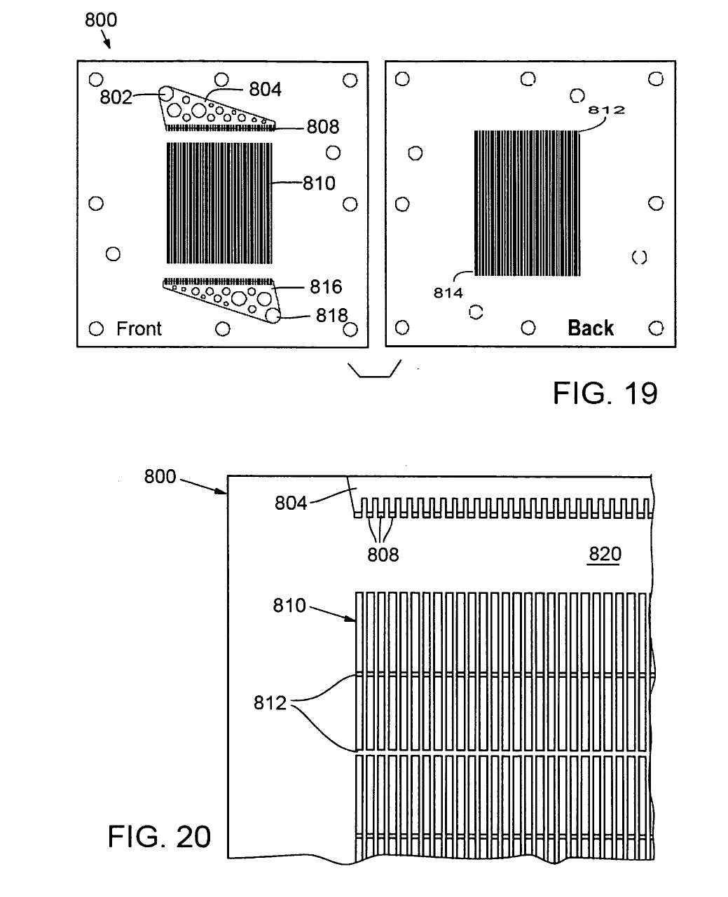

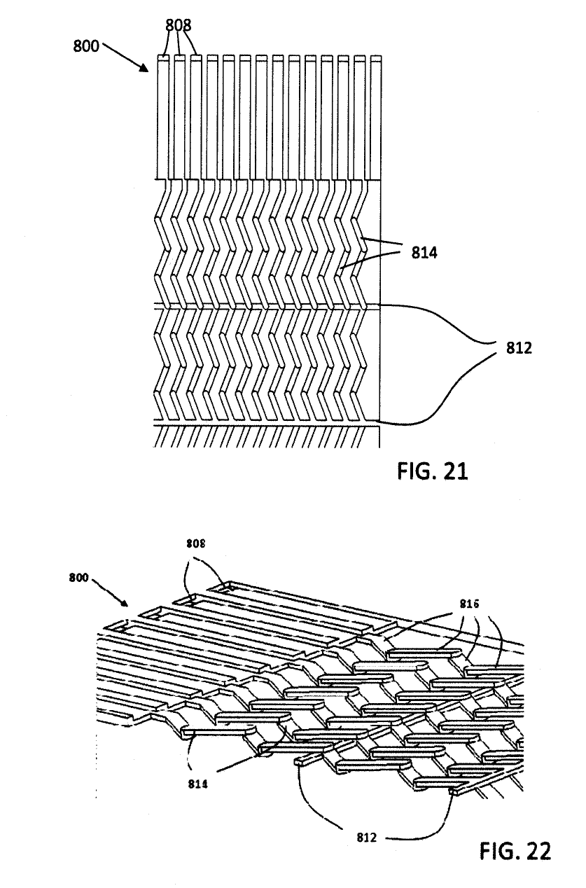

One embodiment of the microfluidic transfer device employs microchannels that are cut through the entire lamina thickness. FIG. 19 is a plan view of a through-cut lamina 800. Lamina 800 has fluid inlet 802, fluidly connected to inlet header 804. Inlet header 804 is fluidly connected to via 808. Through-cut microchannels 810 are fluidly connected to vias 808 by way of microchannels 812. Microchannels 814 fluidly connect through-cut microchannels 810 with outlet header 816, which directs fluid flow to outlet 818. With the microchannels cut through the entire lamina thickness, the microchannel dividers may need structural support. FIG. 20 shows lamina 800 having through-cut microchannels 810 supported by partial thickness dividers 812. To afford a robust compression seal, lamina 800 has a compression seal face 820 for compressing the transfer layer against the adjacent layer. Another embodiment of a through-cut microchannel lamina is shown in FIG. 21.

FIG. 21 shows a plan view of lamina 800 having microchannel dividers forming a herringbone pattern. Referring to FIG. 22, microchannel dividers 814 comprise plural partial thickness wall segments 816 arranged in a herringbone pattern. Partial thickness wall segments 816 alternate in the herringbone pattern such that adjacent wall segments are flush with opposite sides of the lamina 800. This design increases device efficiency by exposing a greater surface area of the transfer layer (not shown).

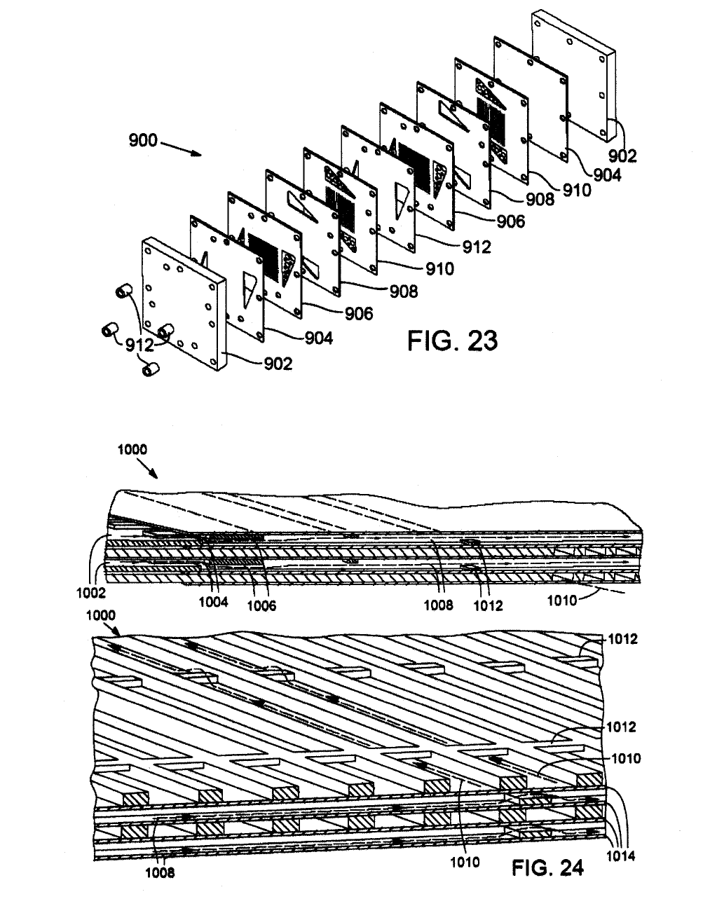

FIG. 23 shows an assembly view of microfluidic transfer device 900 using through-cut laminae 906. Compression plates 902, operatively connected to gaskets 904, hold and compress repeating subunits comprising, in order, first fluid lamina 906, transfer layer 908, and second fluid lamina 910. The subunits are separated by transfer layers 912. One advantage of this embodiment is the increased transfer layer exposure per microchannel. Since the through-cut microchannels are bound on two sides by transfer layers 908 and 912, which operatively connect them to adjacent plates, the transfer layer surface area per lamina is almost doubled. This allows for fewer layers, and allows reduced costs and smaller devices.

FIG. 24 provides a detail of the fluid flow path 1000. Fluid enters the inlet header 1002, which directs the fluid to via 1004. The fluid travels through via 1004 to microchannel 1006, then to through-cut microchannel 1008. Through-cut microchannel 1008 is oriented orthogonal to through-cut microchannel 1010. Through-cut microchannels 1008 and 1010 have partial thickness dividers 1012 for structural support. Additionally, dividers 1012 provide mixing without substantially impeding fluid flow. Transfer layers 1014 separate and operably connect through-cut microchannels 1008 and 1010 to afford heat or mass transfer from one fluid to another.

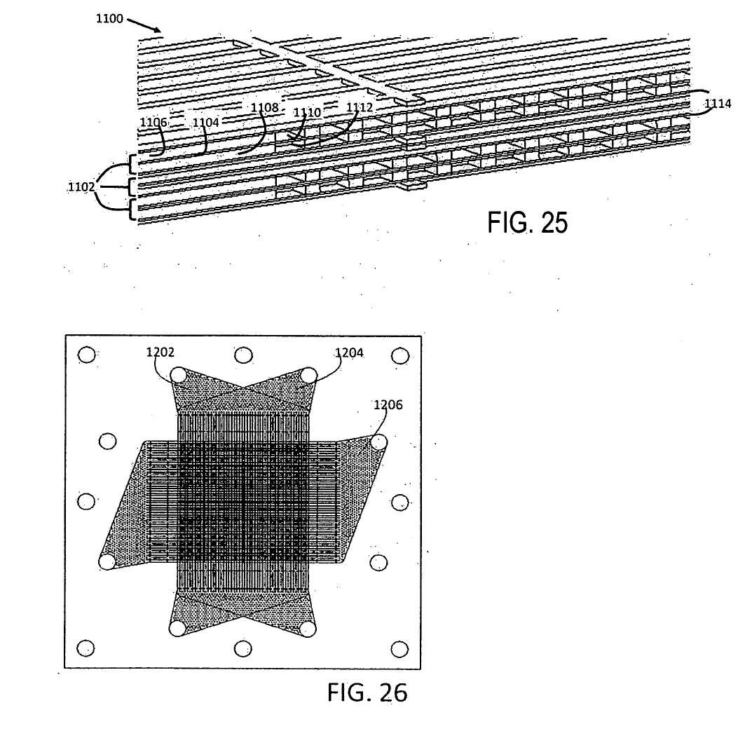

FIG. 25 discloses a detail of a through cut device 1100 having both concurrent and cross current flow. Device 1100 comprises plural subunits 1102. Subunit 1102 comprises a transfer layer 1104 between a first lamina 1106 and a second lamina 1108. Laminae 1106 and 1108 have through-cut microchannels 1110 and 1112, respectively. Microchannels 1110 and 1112 are parallel to each other and orthogonal to microchannels of adjacent subunits 1102. The subunits 1102 are separated by transfer layers 1114. Consequently, subunits 1102 have concurrent or countercurrent flow between laminae 1106 and 1108 within subunit 1102, and crosscurrent flow between subunits.

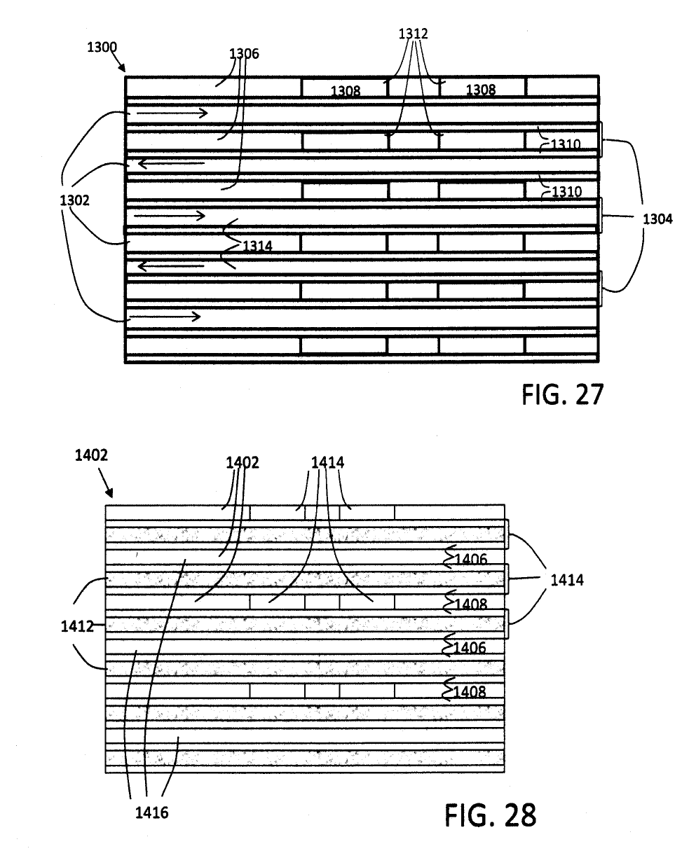

The disclosed device may utilize fluid membranes. FIG. 26 discloses a plan view of the juxtaposition of the process fluid flow paths 1202 and 1204 and the fluid membrane channels 1206. Fluid flow paths 1202 and 1204 are substantially parallel to each other and substantially orthogonal to the fluid membrane channels 1206. Referring now to FIG. 27, fluid membrane device 1300 comprises through-cut laminae separated by fluid membranes 1304. Fluid membranes 1304 comprises through-cut lamina 1306 containing fluid 1308 and membrane supports 1310. Through-cut lamina 1308 has microchannels 1312 substantially orthogonal to microchannels 1314 of through-cut laminae 1302. A person of ordinary skill in the art will recognize that the membrane supports may be any material suitable for liquid membrane applications. For example and without limitation, a microporous polyethylene film may be used as a membrane support. A person of ordinary skill in the art will recognize that the need for, composition and positioning of membranes support will depend on, for example, the fluid used in the fluid membrane, the process fluids, and the operating temperatures and pressures.

The disclosed devise may also be configured as a fuel cell. FIG. 28 discloses a fuel cell device 1400 comprising plural through-cut lamina 1402 separated by a transfer layer 1404 comprising a cathode 1406, an anode 1408, and a polymer electrolyte membrane 1412 therebetween. The device of FIG. 28 may contain, for instance, hydrogen in microchannels 1414, and oxygen in microchannels 1416. Transfer layers 1404 are oriented such that the a node 1408 is adjacent to the microchannels 1414 and the cathode is adjacent to the microchannels 1416. A person of ordinary skill in the art will recognize that this device may be used with any fuel cell and the transfer layer configuration will depend on, for instance, the fuels used and the operating temperature and pressure. A person of ordinary skill in the art will also recognize that the device may also be configured for concurrent or countercurrent flow.

### C. Making Microfluidic Transfer Devices

Devices disclosed herein may be produced by a many of the techniques involved in a fabrication approach known as microlamination. Microlamination methods are described in several patents and pending applications commonly assigned to Oregon State University, including U.S. Pat. Nos. 6,793,831, 6,672,502, and U.S. Publication, Nos. 2007/0029365, entitled High Volume Microlamination Production of Mecs Devices, and 2008/0108122, entitled Microchemical Nanofactories, all of which are incorporated herein by reference.

Microlamination consists of patterning and bonding thin layers of material, called laminae, to generate a monolithic device with embedded features. Microlamination typically involves at least three levels of production technology: 1) lamina patterning, 2) laminae registration, and 3) laminae bonding. Thus, the method of the present invention for making devices comprises providing plural laminae, registering the laminae, and bonding the laminae. Laminae bonding is not required for all disclosed embodiments, as the registered lamina are held between compression plates affording a compression seal. As yet another alternative, certain embodiments may have at least some laminae bonded together in combination with compression. The method also may include dissociating components (i.e., substructures from structures) to make the device. Component dissociation can be performed prior to, subsequent to, or simultaneously with bonding the laminae.

In one aspect of the invention, laminae are formed from a variety of materials, particularly metals; alloys, including intermetallic metals and super alloys; polymeric materials, including solely by way of example and without limitation, polycarbonate, polyethylene terephthalate (PET), polyether imide (PEI), poly(methyl methacrylate) (PMMA), and halogenated polyethylene such as poly(tetrafluoroethylene) (PTFE); ceramics; and combinations of such materials. The proper selection of a material for a particular application will be determined by various factors, such as the physical properties of the metal or metal alloy and cost. Examples of metals and alloys particularly useful for metal microlamination include stainless steels, copper, titanium, nickel, and aluminum. Laminae useful for the microlamination method of the present invention can have a variety of sizes. Generally, the laminae have thicknesses of from about 25 μm to about 1000 μm thick, preferably from about 25 μm to about 500 μm thick, and even more preferably from about 25 μm to 250 μm thick. Individual lamina within a stack also can have different thicknesses.

1. Lamina Patterns

Lamina patterning may comprise machining or etching a pattern in the lamina. Lamina patterning may also comprise embossing, roll embossing, and/or stamping. The pattern produced depends on the device being made. Without limitation, techniques for machining or etching include laser-beam, electron-beam, ion-beam, electrochemical, electrodischarge, chemical and mechanical material deposition or removal. The lamina can be patterned by combinations of techniques, such as both lithographic and non-lithographic processes. Lithographic processes include micromolding and electroplating methods, such as LIGA, and other net-shape fabrication techniques. Some additional examples of lithographic techniques include chemical micromachining (i.e., wet etching), photochemical machining, through-mask electrochemical micromachining (EMM), plasma etching, as well as deposition techniques, such as chemical vaporization deposition, sputtering, evaporation, and electroplating. Non-lithographic techniques include electrodischarge machining (EDM), mechanical micromachining and laser micromachining (i.e., laser photoablation). Photochemical and electrochemical micromachining likely are preferred for mass-producing devices.

One method for patterning lamina for disclosed device embodiments is microembossing. For instance, certain embodiments of the present disclosure were made using the following techniques. An Obducat Nano Imprint Lithography system was used to transfer microscale patterns from masters to polymeric parts. Master fabrication was accomplished by micromilling masters in metal, such as aluminum. A double transfer process using another material, such as polyether imide (PEI), as the intermediate was also used. A triple transfer process using patterned photoresist as the starting master was also used. The pattern was transferred from the photoresist, typically SU-8, to polydimethylsiloxane (PDMS), then to a thermoset epoxy (e.g., Conapoxy FR-1080) which then was used as the embossing master in the Obducat tool, transferring the pattern to a lower melting temperature polymer, such as polyethylene terephthalate (PET). The SU-8 can be deposited and patterned in multiple layers, allowing creation of precision multiplane masters. These planes can be both above and below the plane with the compression seal, allowing, for example, formation of protruding features such as sealing bosses as well as channels with multiple depths. Laminae also can be embossed on both sides simultaneously used two masters. Alignment techniques such as marks and pins were used during prototyping. It is anticipated that volume production will be accomplished using roll embossing and lamination techniques, also known as conversion processes, that will include automated alignment using vision systems.

Another method used for making disclosed embodiments was photochemical etching of metal laminae, e.g., 316/316L stainless steel. Patterned photoresist was used to mask both the front and back side of the laminae, with different masking patterns for each side. Partial etching from each side created intricate flow channels, including vias from one side to the other and channels open to both sides. Small support structures used to stabilize the channel dividers were also created. Such structures can be used to create segmented channel divider architectures, thereby increasing the active surface area of the transfer layer.

Laser machining was also used to cut vias, inlet and outlet ports, and alignment pin holes in laminae as well as embossing masters. An ESI 5330 with a 355 nm wavelength laser was used for laser machining. In volume production a laser may be also used to cut vias and other penetrations. To create the via, the angle of the laser will preferably be non-orthogonal to create a non-orthogonal via, thereby reducing dead volumes in the flow channel. Alternatively, the vias and other penetrations may be created using a stamping operation. The stamping operation may be accomplished as part of the embossing operation through design of appropriate embossing/stamping masters. Non-orthogonal vias in particular are also created by designing appropriate embossing/stamping masters.

Laser micromachining has been accomplished with pulsed or continuous laser action. Machining systems based on Nd:YAG and excimer lasers are typically pulsed, while CO₂ laser systems are continuous. Electro Scientific Industries model 4420 is a typical system for Nd:YAG. This micromachining system uses two degrees of freedom by moving the focused laser flux across a part in a digitally controlled X—Y motion. The cutting action is either thermally or chemically ablative, depending on the material being machined and the wavelength used. The drive mechanism for the Nd:YAG laser may be a digitally controlled servo actuator that provides a resolution of approximately 2 μm. The width of the through cut, however, depends on the diameter of the focused beam.

Laminae also have been machined with CO₂ laser systems. Most of the commercial CO₂ lasers semi-ablate or liquefy the material being cut. A high-velocity gas jet often is used to help remove debris. As with the Nd:YAG systems, the laser (or workpiece) is translated in the X—Y directions to obtain a desired pattern in the material.

An Nd:YAG pulse laser has been used to cut through, for example, 90-μm-thick steel shims. The line widths for these cuts were approximately 35 μm wide, although with steel, some tapering was observed. Some debris and ridging may occur along the edge of the cut on the front side. This material may be removed easily from the surface during lamina preparation, such as by surface polishing.

Laminae also may be patterned using a CO₂ laser. The CO₂ through-cuts were approximately 200 μm wide and also exhibited a slight taper. The width of the CO₂ laser cut was the minimum achievable with the system used. The part may be cleaned in a lamina preparation step using surface polishing to remove debris.

Pulsed Nd:YAG lasers also are capable of micromachining laminae made from polymeric materials, such as laminae made from polyimides. Pulsed Nd:YAG lasers are capable of micromachining these materials with high resolution and no recast debris. Ultraviolet wavelengths appear best for this type of work where chemical ablation apparently is the mechanism involved in removing material. Clean, sharp-edged holes in the 25-50 μm diameter range have been produced.

2. Lamina Preparation

Depending on the lamina and patterning technique used, lamina patterning may include lamina preparation. The laminae can be prepared by a variety of techniques. For example, surface polishing of a lamina following pattern formation may be beneficial. Moreover, acid etching can be used to remove any oxides from a metal or alloy lamina. Lamina preparation may also include applying an oxide-free coating to some or all of the laminae. An example of this would be electroplating gold onto the lamina to prevent oxidation at ambient conditions.

3. Registration

Laminae registration comprises (1) stacking the laminae so that each of the plural lamina in a stack used to make a device is in its proper location within the stack, and (2) placing adjacent laminae with respect to each other so that they are properly aligned as determined by the design of the device. It should be recognized that a variety of methods can be used to properly align laminae, including manually and visually aligning laminae.

The precision to which laminae can be positioned with respect to one another may determine whether a final device will function. The complexity may range from structures such as microchannel arrays, which are tolerant to a certain degree of misalignment, to more sophisticated devices requiring highly precise alignment. A person of ordinary skill in the art will recognize that microchannels on adjacent laminae that are parallel to each other require a greater precision of alignment that embodiments having cross current flow. Several alignment methods can be used to achieve the desired precision. Registration can be accomplished, for example, using an alignment jig that accepts the stack of laminae and aligns each using some embedded feature, e.g., corners and edges, which work best if such features are common to all laminae. Another approach incorporates alignment features, such as holes, into each lamina at the same time other features are being machined. Alignment jigs are then used that incorporate pins that pass through the alignment holes. The edge alignment approach can register laminae to within 10 microns, assuming the laminae edges are accurate to this precision. With alignment pins and a highly accurate lamina machining technique, micron-level positioning is feasible.

Vision systems and thermally assisted lamina registration also can be used as desired. Additional detail concerning thermally assisted lamina registration is provided by Patent Publication No. 2007/0029365, which is incorporated herein by reference. A person of ordinary skill in the art also will recognize that the registration process can be automated.

4. Manufacture of Devices

Laminae bonding comprises bonding at least some of plural laminae one to another to produce a monolithic device (also referred to as a laminate). Laminae bonding can be accomplished by a number of methods including, without limitation, diffusion soldering/bonding, thermal brazing, adhesive bonding, thermal adhesive bonding, curative adhesive bonding, electrostatic bonding, resistance welding, microprojection welding, and combinations thereof In addition to or as an alternative to bonding the registered lamina, the disclosed device may be assembled between compression plates. However, for some applications, bonding the lamina to the transfer layer may be preferable. Additionally, a bond or weld, such as a laser tack weld, may be used to facilitate assembly during manufacture.

A preferred method of device fabrication involves high through-put, low cost fabrication techniques. Laminae patterning is accomplished using several techniques, including embossing, stamping, and photochemical etching, among others. In one preferred embodiment, assembly is accomplished using roll techniques, such as those used in web processing or conversion industries. Polymer films are roll embossed and stamped, then laminated to form a subassembly. Metal laminae are patterned using photochemical etching. Abrasive waterjet techniques under development now may also be used for patterning metal laminae in the future. The subassemblies are separated, stacked, and assembled in compression frames. The primary sealing method is by compression from an external frame, however, bonding techniques such as laser welding and adhesives may be used for portions of some embodiments. A sealant or sealing method may be applied to the edges to prevent external seepage through the membrane.

In view of the many possible embodiments to which the principles of the disclosed device may be applied, it will be recognized that the illustrated embodiments are only preferred examples and should not be construed as limiting the claims to a scope narrower than would be appreciated by a person of ordinary skill in the art. Rather, the scope is defined by the following claims. Moreover, a person of ordinary skill in the art would recognize that the plural dependent claims are substantially equally applicable to each independent claim. We therefore claim all that comes within the scope and spirit of these claims.

We claim:

1. A microchannel device, comprising:
plural laminae, at least one lamina having a front side defining front side features and a back side defining back side features, the front side features being fluidly connected to the back side features by at least one via; and
at least one transfer layer interleaving the laminae.

2. The microchannel device according to 1 where the front side features comprise an inlet header and an outlet header and the back side features comprise plural microchannels, the inlet header fluidly connected to the microchannels by one or more inlet vias, and the outlet header fluidly connected to the microchannels by one or more outlet vias.

3. The device according to 2 where a first lamina, a second lamina, and a transfer layer form a subunit, the first lamina and the second lamina having a front side and a back side, where the transfer layer is positioned between the back side of the first lamina and the back side of the second lamina.

4. The device according to 3 having plural subunits positioned between a first and a second compression plate.

5. The device according to 4 further comprising gaskets positioned between subunits.

6. The device according to 4 where front sides of the first laminae of adjacent subunits are mirror images of each other and face each other, and where front sides of the second laminae of adjacent subunits are mirror images of each other and face each other.

7. The device according to 1 comprising plural laminae, each having backside features defining microchannels, where the microchannels of each lamina are substantially parallel or substantially orthogonal to the microchannels of at least one adjacent lamina.

8. The device according to 4 where the back sides of the first lamina and the second lamina further comprise an inlet header and an outlet header, and the front sides of the first lamina and the second lamina further comprise microchannels fluidly connected to the inlet header on the back side by one or more vias and fluidly connected to the outlet header on the back side by one or more vias, and further comprising transfer layers positioned between the subunits.

9. The device according to 8 where the transfer layers are substantially sealed to adjacent laminae between the inlet headers and the microchannels and between the outlet headers and the microchannels.

10. The device according to 2 where a substantial portion of the microchannels extend from the front side to the back side to form through-cut microchannels, the through-cut microchannels fluidly connected to the one or more inlet vias by first partial thickness microchannels and the through-cut microchannels fluidly connected to the one or more outlet vias by second partial thickness microchannels.

11. The device according to 1 where the at least one transfer layer is a mass transfer layer.

12. The device according to 11 where the mass transfer layer is a membrane or semi-permeable membrane.

13. The device according to 12 where the membrane or semi-permeable membrane comprises polymer, copolymer, metal, ceramic, composite, or fluid membrane material.

14. The device according to 13 where the semi-permeable membrane is polysulfone-nanocrystalline cellulose composite membranes.

15. The device according to 12 where the semi-permeable membrane is a fluid membrane, the fluid membrane comprising a lamina having through-cut microchannels containing fluid and a first membrane support and a second membrane support positioned to contain fluid in the microchannels.

16. The device according to 1 where the at least one transfer layer is a heat transfer layer.

17. The device according to 1 configured for both heat transfer and mass transfer.

18. The device according to 1 where the back side features comprise a flow field defining plural wall segments.

19. The device according to 10 where the microchannels are formed by partial thickness wall segments arranged in a herringbone pattern, and where adjacent wall segments alternate between being flush with the front side of the lamina and flush with the back side of the lamina.

20. The device according to 10 where a first lamina, a second lamina, and a transfer layer form a subunit, the device comprises plural subunits, the microchannels of the first lamina are substantially parallel or substantially orthogonal to the microchannels of the second lamina, and the microchannels of adjacent subunits are orthogonal.

21. The device according to 2 where the at least one via is non orthogonal to the front side and back side.

22. The device according to 2 where the at least one transfer layer defines cutouts corresponding to the inlet header and the outlet header.

23. A microchannel device, comprising:
plural lamina, at least one of the lamina having a front side defining an inlet header and an outlet header and a backside defining at least one backside feature, the inlet header and outlet header fluidly connected to the at least one back side feature by one or more vias, where at least one via is a non-orthogonal via; and
at least one transfer layer interleaving the laminae, the transfer layer defining cutouts corresponding to the inlet header and the outlet header.

24. A microchannel device, comprising:
plural laminae, at least one lamina having an inlet header and an outlet header; and
at least one transfer layer interleaving the laminae, the at least one transfer layer having cutouts corresponding to the inlet header and the outlet header of the at least one lamina.

25. The device according to 24 where a first lamina, a second lamina, and a transfer layer form a subunit, the first and second lamina having microchannels, and where the transfer layers are positioned between microchannels of adjacent laminae.

26. The device according to 24 where the inlet headers and the outlet headers further define plural structural support posts.

27. The device according to 24 where the inlet header defines an inlet port and outlet header defines an outlet port ports, and where the inlet header and the outlet header are shaped to provide approximately equal flow-path lengths between the inlet port and the outlet port.

28. The device according to 27 where the inlet header and the outlet header are shaped as approximately triangular.

29. A microchannel device, comprising:
plural laminae, at least one lamina having a front side and a back side and defining one or more vias for fluidly connecting the front side and the back side, at least one via intersecting the front side and back side at a non-orthogonal angle; and
at least one transfer layer interleaving the laminae.

30. The device according to 29 further comprising front side features fluidly connected by the one or more vias to back side features.

31. The device according to 30 where a first lamina, a second lamina, and a transfer layer form a subunit.

32. The device according to 31 having plural subunits and positioned between a first and a second compression plate.

33. The device according to 32 further comprising at least one gasket positioned between the subunits.

34. The device according to 30 where the front side features comprise an inlet header and an outlet header and the back side features comprise microchannels.

35. A method for transferring heat or a substance from one fluid to another, comprising:
providing a microchannel transfer device having at least a first and a second lamina interleaved with at least one transfer layer, the laminae having a front side and a back side, the front side having an inlet header fluidly connected to plural microchannels on the back side by one or more inlet vias, the microchannels fluidly connected to an outlet header on the front side by one or more outlet vias, the first layer for receiving at least a first fluid and the second layer for receiving at least a second fluid;
providing the first fluid to the inlet header of the first lamina; and
providing the second fluid to the inlet header of the second lamina.

36. The method of 35 where the microchannels of the first layer are parallel to the microchannels of the second layer.

37. The method according to 36 where the first fluid flows in the same direction as the second fluid.

38. The method according to 36 where the first fluid flows in the opposite direction as the second fluid.

39. The method according to 35 where the transfer layer is a semi-permeable membrane, the first fluid is blood, and the second fluid is dialysate.

40. The method according to 39 where the semi-permeable membrane is a polysulfone-nanocrystalline cellulose composite.

41. The method of 35 where the microchannels of the first layer are orthogonal to the microchannels of the second layer.

42. The method of 35 where the transfer layer is a heat transfer layer.

43. A method for making a microfluidic device, comprising:
providing plural laminae having a front side defining front side features and a back side defining back side features, at least one front side feature fluidly connected to at least one back side feature by one or more vias;
providing plural transfer layers;
aligning the plural laminae and interleaving the plural laminae with the plural transfer layers to form a stack;
positioning the aligned plural laminae and plural transfer layers between a first compression plate and second compression plates; and
compressing the stack.

44. The method according to 43 where the first compression plate has at least one apertures fluidly connected to at least one front side feature.
